(19) United States
(12) Patent Application Publication
(10) Pub. No.: US 2024/0362650 A1
(43) Pub. Date: Oct. 31, 2024

(54) COMPUTING SYSTEM FOR ACHIEVING TRACEABILITY IN A FOOD COMMODITY SUPPLY CHAIN

(71) Applicant: Microsoft Technology Licensing, LLC, Redmond, WA (US)

(72) Inventors: Vaishnavi NATTAR RANGANATHAN, Woodinville, WA (US); Roberto Oliveira SANTOS, Curitiba (BR); Peeyush KUMAR, Seattle, WA (US); Bruno SILVA, Recife (BR); Ranveer CHANDRA, Kirkland, WA (US)

(73) Assignee: Microsoft Technology Licensing, LLC, Redmond, WA (US)

(21) Appl. No.: 18/309,563

(22) Filed: Apr. 28, 2023

(51) Int. Cl. G06Q 30/018

(52) U.S. Cl. CPC G06Q 30/018; G06K 7/1413

(57) ABSTRACT

A computing system for achieving traceability in a food commodity supply chain is provided, including a server computing device configured to receive a message indicating an optical code associated with a unit of a food product has been scanned by a camera-equipped computing device at a location, in which the message includes a product unit-specific identifier encoded in the optical code. The server computing device is further configured to identify in a database, a merchant record including the product unit-specific identifier and a merchant identifier of a merchant at the location. The server computing device is further configured to trace a supply chain path of the unit of the food product through additional records in the database that are linked to the product unit-specific identifier, and output supply chain derived information on the unit of the food product based on the traced supply chain path.

### BACKGROUND

There has been increasing emphasis placed upon accountability and sustainability of food commodities that travel through supply chains to reach end consumers. Consumers are coming to demand that the items they purchase are available at the peak of freshness and have been produced in a socially, environmentally, and economically sustainable manner. For example, consumers are more conscious of a product's carbon footprint, raw material usage, and water usage over its production life, as well as the environmental practices of various companies involved in its production and transportation along the supply chain. Opportunities exist for technical solutions to be developed that enable consumers, businesses, and regulatory agencies alike to gain insights as to the sustainability, quality, and nutritional value of food commodities that pass through such supply chains, particularly produce and other perishables. Deepening their understanding of where food commodities are grown and how food commodities move through supply chains can enable increased accountability for the handling of those food commodities throughout the supply chains.

### SUMMARY

A computing system for achieving traceability in a food commodity supply chain is provided. According to one aspect, the computing system comprises a server computing device having one or more processors configured to execute instructions using portions of associated memory to receive a message indicating an optical code associated with a unit of a food product has been scanned by a camera-equipped computing device at a location, in which the message includes a product unit-specific identifier encoded in the optical code. The server computing device is further configured to identify in a database, a merchant record including the product unit-specific identifier and a merchant identifier of a merchant at the location. The server computing device is further configured to trace a supply chain path of the unit of the food product through additional records in the database that are linked to the product unit-specific identifier, and output supply chain derived information on the unit of the food product based on the traced supply chain path.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for achieving traceability in a food commodity supply chain according to one example implementation of the present disclosure.

FIGS. 2A-2E each show an example graphical user interface (GUI) of a tracking and tracing tool, which is displayed on a camera-equipped computing device of the system of FIG. 1.

FIG. 3 illustrates an example supply chain path of the unit of the food product traced by the system of FIG. 1.

FIG. 4 illustrates an example ledger in a database including the records of data to be displayed on a camera-equipped computing device of the computing system of FIG. 1.

FIG. 5 illustrates an example map including locations of supply chain entities to be displayed on a camera-equipped computing device of the system of FIG. 1.

FIG. 6 is a flowchart of a method for achieving traceability in a food commodity supply chain according to one example configuration of the present disclosure.

FIG. 7 is a schematic view of an example computing system according to one implementation of the present disclosure.

### DETAILED DESCRIPTION

In the case of food commodities, sustainability can be difficult to measure because it is difficult to trace the movement of such food commodities through various supply chain operations. Aggregation and intermixing of food commodities at various stages in the supply chain can lead to loss of identifying information of the food commodities, limiting the traceability of food commodities back to their sources. The issue of traceability is particularly impactful for high-volume, low-cost products such as grains, as information that is lost between the harvest stage and the storage stage may cause inability to trace portions of harvested crops infected by food-borne illnesses and disease causing bacteria. This inability can lead to mass recalls that result in large amounts of food loss. These losses are further amplified by the extended periods of time (e.g., 1-2 years) that harvested products often spend in transit, involving multiple supply chain entities. Furthermore, many nutrients in the product can degrade over time, post-harvest. Improper storage and treatment can accelerate the degradation. Traceability information can be combined with local sensor data indicating environmental conditions at each location along the supply chain, to enable computer modeling of these nutrient levels in the products as they travel the supply chain. Thus, achieving traceability can not only help an organization achieve sustainability goals in supply-chain operations, but promote nutrition goals as well.

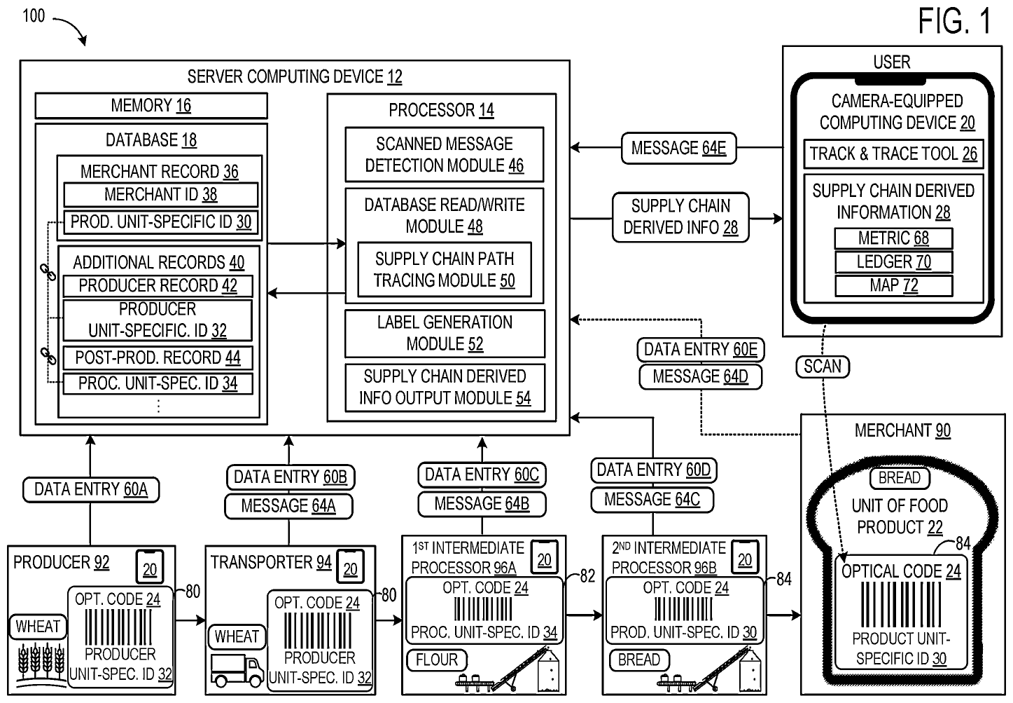

As schematically illustrated in FIG. 1, to address the issues identified above, a computing system 100 for achieving traceability in a food commodity supply chain is provided. As illustrated in FIG. 1, the computing system 100 comprises a server computing device 12 having one or more processors 14 configured to execute instructions using portions of associated memory 16 to communicate with camera-equipped computing devices 20 via a computer network such as the Internet. The server computing device 12 may be one of a plurality of server devices in a data center, and the one or more processors 14 may be one processor of a single server device or multiple processors of multiple server devices. Below, the functions of the server computing device 12 as executed by the one or more processors 14 are described by way of example, and this description shall be understood to include execution on the one or more processors 14 distributed among one or more of the server computing devices 12 discussed above. On the client side, one example camera-equipped computing device 20 may be used by entities including food commodities producers, merchants and end consumers to communicate with the server computing device 12. For example, the camera-equipped computing device 20 can be a mobile computing device such as a smartphone or tablet that includes a camera for scanning a label including an optical code.

Continuing with FIG. 1, the associated memory 16 may store instructions that cause the processor 14 to receive a producer data entry 60A including product information for a unit of a food commodity from the camera-equipped computing device 20 of a producer 92. For example, the producer data entry 60A may include information on a label, a product type (e.g., wheat), seed type (e.g., non-genetically modified (GMO)), organic labeling, a supply chain stage (e.g., farm), scanned time, and/or a location of the producer 92 (e.g., latitude and longitude). Upon a request by the producer 92, the processor 14 is further configured to generate a producer label 80 configured to be placed on the unit of the food commodity or packaging of the food commodity, in which the producer label 80 includes the optical code 24 encoding a producer unit-specific identifier 32. The optical code 24, which is associated with the unit of the food commodity, may be a barcode, a Quick Response (QR) code, or an alphanumeric code that can be scanned by the camera-equipped computing device 20. The processor 14 is further configured to write, via a database read/write module 48, the producer data entry 60A and the producer label 80 to a database 18 as a producer record 42.

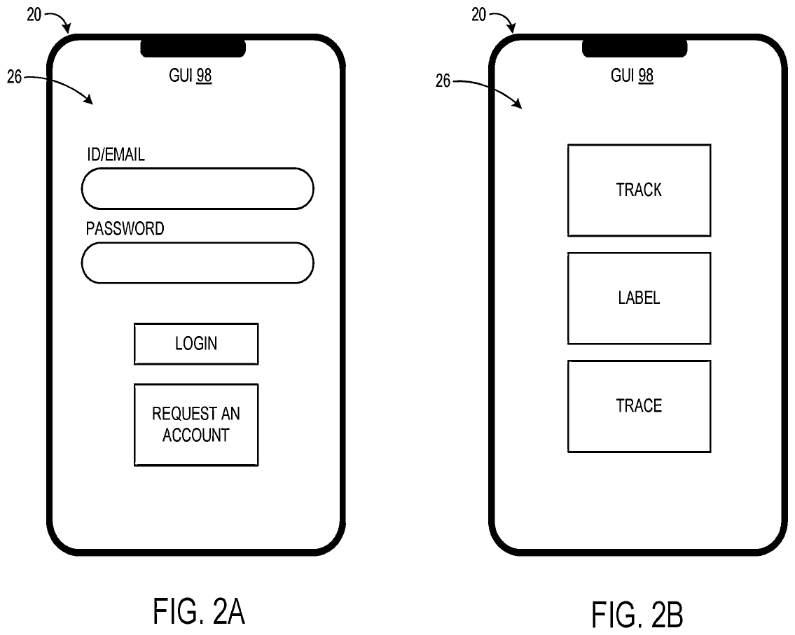

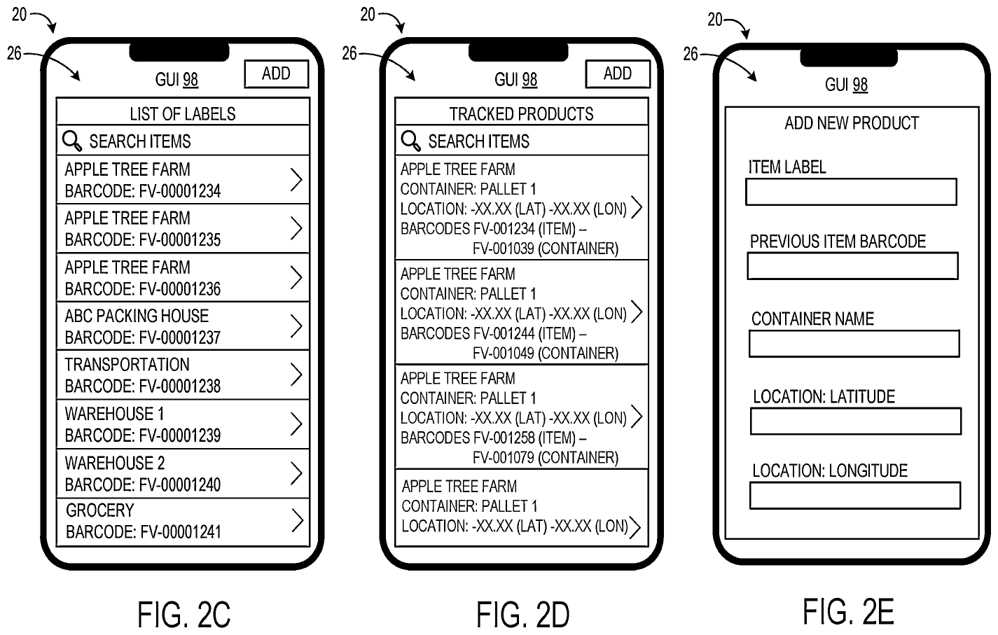

In the depicted example of FIG. 1, when the producer 92 harvests or ships out wheat, the producer 92 enters the producer data entry 60A via a tracking and tracing tool 26 of the camera-equipped computing device 20. Further, the producer 92 makes the producer label 80 on his/her own or requests the producer label 80 on the camera-equipped computing device 20. Turning briefly to FIGS. 2A-2E, shown is an example graphical user interface (GUI) 98 of the tracking and tracing tool 26, which is displayed on the camera-equipped computing device 20. FIG. 2A illustrates a login and account registration GUI of the tracking and tracing tool 26 and FIG. 2B illustrates a menu GUI including “TRACK,” “LABEL,” and “TRACE” selectors of the tracking and tracing tool 26. When the “LABEL” selector is selected, a list of created labels is displayed as shown at FIG. 2C. A new label including the above producer label 80 can be created and added to the list by selecting “ADD” on the GUI 98. When the “TRACK” selector is selected, a list of tracked products is displayed as shown at FIG. 2D. A new product data entry including the above the producer data entry 60A can be created and added by selecting “ADD” on the GUI 98. When a new entry is added and/or a new label is requested by the producer 92 via the tracking and tracing tool 26, the server computing device 12 receives the producer data entry 60A and/or generates the producer label 80. The producer 92 attaches the generated producer label 80 to a unit of wheat or a packaging of the unit of wheat and hands the unit of wheat or the packaging of the unit of wheat to supply chain entities including a transporter 94.

Returning to FIG. 1, the processor 14 is configured to receive a message 64A indicating a scan of the producer label 80 by the camera-equipped computing device 20 of the supply chain entity. The processor 14 is further configured to receive a post-production data entry 60B from the supply chain entity, in which the post-production data entry 60B includes post-production supply chain information and the producer unit-specific identifier 32. The processor 14 is further configured to write the post-production data entry 60B to the database 18. In the depicted example of FIG. 1, the transporter 94 receiving the unit of the food commodity from the producer 92 may scan the producer label 80 to check supply chain path information including the producer data entry 60A. Further, the transporter 94 may enter the post-production data entry 60B by selecting “TRACK” on the tracking and tracing tool 26 (see FIG. 2B) as discussed above. Although the transporter 94 may create the post-production label 82 on his/her own or request the post-production label 82 through the tracking and tracing tool 26, the transporter usually continues to use the producer label 80 including the producer unit-specific identifier 32, since there is no change to the unit of the food commodity; in this case, the unit of wheat or the packaging of the unit of wheat remains unchanged throughout transport. The server computing device 12 receives the message 64A from the camera-equipped computing device 20 of the transporter 94 and sends the supply chain path information to the camera-equipped computing device 20 of the transporter 94. When a new entry is added by the transporter 94 via the tracking and tracing tool 26, the server computing device 12 receives the post-production data entry 60B and adds the information to the database 18. The post-production data entry 60B may include information on the supply chain stage (e.g., transporter), scanned time, a location of the transporter 94 (e.g., latitude and longitude), and/or local sensor information such as storage conditions and other stage-relevant information. The storage conditions indicated by the local sensor information may include the temperature (including time-at-temperature), humidity, UV exposure, etc., at which the product is stored at the supply chain stage. The transporter 94 delivers the unit of wheat or the packaging of the unit of wheat to a first intermediate processor 96A for food processing.

Continuing with FIG. 1, the processor 14 is further configured to receive a message 64B indicating a scan of the post-production label 82 by the camera-equipped computing device 20 of the first intermediate processor 96A. The processor 14 is further configured to receive a post-production data entry 60C from the first intermediate processor 96A, in which the post-production data entry 60C includes the post-production supply chain information and a processor unit-specific identifier 34 that is linked to the producer unit-specific identifier 32. The processor 14 is further configured to generate the post-production label 82 configured to be placed on the unit of the food commodity or packaging thereof, in which the post-production label includes the optical code 24 encoding the processor unit-specific identifier 34, and write the post-production data entry 60C to the database 18. The first intermediate processor 96A receiving the unit of the food commodity from the transporter 94 may scan the post-production label 82 to check the supply chain path information including the producer data entry 60A and the post-production data entry 60B. Further, when the first intermediate processor 96A makes a unit of another food commodity (e.g., flour) from the unit of the food commodity (e.g., wheat) or is ready to ship out the unit of the transformed food commodity (e.g., flour) to a second intermediate processor 96B or a merchant 90, the first intermediate processor 96A may enter the post-production data entry 60C by selecting “TRACK” and “ADD” on the tracking and tracing tool 26 (see FIG. 2B) as discussed above. Moreover, the first intermediate processor 96A may create the post-production label 82 including a new unit-specific identifier on his/her own or request the post-production label 82 including the new unit-specific identifier through the tracking and tracing tool 26, since the unit of the food commodity (e.g., wheat) has transformed to the unit of another food commodity (e.g., flour). The server computing device 12 receives the message 64B from the camera-equipped computing device 20 of the first intermediate processor 96A and sends the supply chain path information to the camera-equipped computing device 20 of the first intermediate processor 96A. When a new entry is added and/or a new label is requested by the first intermediate processor 96A via the tracking and tracing tool 26, the server computing device 12 receives the post-production data entry 60B and writes the information to the database 18, and/or generates the post-production label 82 including the processor unit-specific identifier 34 for the first intermediate processor 96A. The post-production data entry 60C may include information on the supply chain stage (e.g., processor), the product type (e.g., flour, bread), scanned time, local sensor information such as processing conditions and location-relevant processing information, and/or a location of the first intermediate processor 96A (e.g., latitude and longitude). The local sensor information may indicate processing conditions such as temperature (including time-at-temperature), humidity, UV exposure, etc. The first intermediate processor 96A attaches the generated post-production label 82 to the unit of the new food commodity (e.g., flour) or the packaging of the unit of the new food commodity (e.g., flour) and delivers to the second intermediate processor 96B for further processing. If the first intermediate processor 96A makes the unit of food product (e.g., bread) from the unit of the food commodity (e.g., wheat), the first intermediate processor 96A may deliver the unit of the food product (e.g., bread) to the merchant 90 by bypassing the second intermediate processor 96B.

The second intermediate processor 96B receiving the unit of the food commodity from the first intermediate processor 96A may scan the post-production label 82 to check the supply chain path information including the producer data entry 60A and the post-production data entries 60B, 60C. Further, when the second intermediate processor 96B makes the unit of food product 22 (e.g., bread) from the unit of the food commodity (e.g., flour) or is ready to ship out the unit of the food product 22 (e.g., bread) to the merchant 90, the second intermediate processor 96B may enter the post-production data entry 60D by selecting “TRACK” on the tracking and tracing tool 26 (see FIG. 2B) as discussed above. Moreover, the second intermediate processor 96B may create the post-production label 84 including a new unit-specific identifier on his/her own or request the post-production label 84 including the new unit-specific identifier through the tracking and tracing tool 26, since the unit of the food commodity (e.g., flour) has transformed to the unit of the food product (e.g., bread). The server computing device 12 receives the message 64C from the camera-equipped computing device 20 of the second intermediate processor 96B and sends the supply chain path information to the camera-equipped computing device 20 of the second intermediate processor 96B. When a new entry is added and/or a new label is requested by the second intermediate processor 96B via the tracking and tracing tool 26, the server computing device 12 receives the post-production data entry 60D and writes the information to the database 18, and/or generates the post-production label 84 including a product unit-specific identifier 30 for the second intermediate processor 96B. The post-production data entry 60D may include information on the supply chain stage (e.g., processor), the product type (e.g., flour, bread), scanned time, and/or a location of the second intermediate processor 96B (e.g., latitude and longitude). The second intermediate processor 96B attaches the generated post-production label 84 to the unit of food product 22 (e.g., bread) or the packaging of the unit of the food product (e.g., bread) and delivers to the merchant 90 such as a grocery store or a restaurant. It will be appreciated that the original data entered by the producer and supply chain entities is immutable.

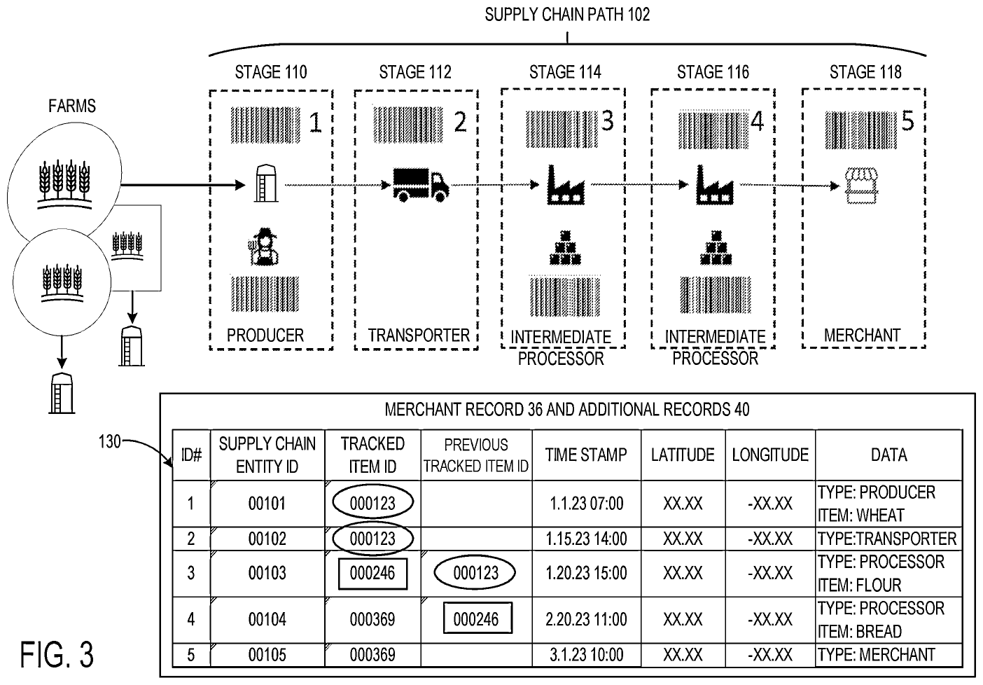

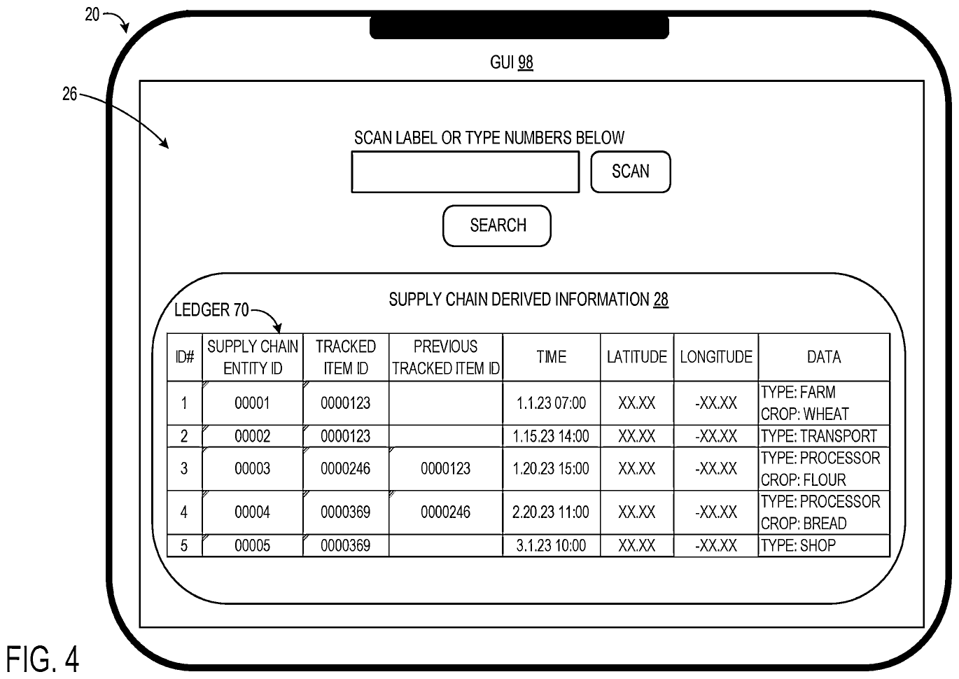

Continuing with FIG. 1, the processor 14 is configured to receive a message 64D indicating the optical code 24 associated with the unit of the food product 22 has been scanned by the camera-equipped computing device 20 at a location, in which the message 64D includes the product unit-specific identifier 30 encoded in the optical code 24. The processor 14 is further configured to identify in the database 18, via a supply chain path tracing module 50, a merchant record 36 including the product unit-specific identifier 30 and a merchant identifier 38 of the merchant 90 at the location, and trace through additional records 40 in the database 18 that are linked to the product unit-specific identifier 30. The additional records 40 may be further linked to other process-specific information including sensor data from associated locations (e.g., warehouse, processing plant/transport unit). The additional records 40 may include records of data obtained from the supply chain entities including the producer 92, transporter 94, distributor, intermediate processor 96, and/or merchant 90, as discussed above. The additional records 40 may further include a producer record 42 including the producer unit-specific identifier 32 that is linked to the product unit-specific identifier 30 and including a producer identifier of the producer 92 and a location of the producer. The additional records 40 may further include a post-production record 44 including the processor unit-specific identifier 34 that is linked to the producer unit-specific identifier 32 and including a transporter identifier of the transporter 94 and a location of the transporter. Additionally, the additional records 40 may include the post-production record 44 including the product unit-specific identifier 30 that is linked to the producer unit-specific identifier 32 and the processor unit-specific identifier 34 and including the intermediate processor identifier of the intermediate processor and a location of the intermediate processor. The processor 14 is further configured to output, via a supply chain derived information output module 54, supply chain derived information 28 on the unit of the food product 22 to the camera-equipped computing device 20 of the user based on the traced supply chain path. Examples of the supply chain derived information 28 include traceability information, a shelf-life metric, nutrition metric, and/or sustainability metric, as discussed further below. In the depicted example of FIG. 1, a user such as an end customer shopping at the merchant 90 or an employee at a restaurant scans the post-production label 84 including the optical code 24 via the tracking and tracing tool 26 of the camera-equipped computing device 20 to receive the supply chain derived information 28 from the server computing device 12. The user selects “TRACE” on the tracking and tracing tool 26 (see FIG. 2B) and selects “SCAN” (see FIGS. 3 and 4) to scan the post-production label 84 and receive the supply chain derived information 28. The server computing device 12 receives the scanned message 64D from the user, and identifies the merchant record 36 including the product unit-specific identifier 30 as well as additional records 40 including the producer record 42 and transporter record 44 that are linked to the product unit-specific identifier 30 to trace the supply chain path of the unit of the food product 22.

Turning briefly to FIG. 3, illustrated is an example supply chain path 102 of the unit of the food product 22. As shown at stages 1-5 of FIG. 3, the supply chain path 102 begins with the producer 92 producing the unit of the food commodity, travels through the transporter and intermediate processors, and ends with the merchant selling the unit of the food product 22. As shown at Table 130, the merchant record 36 and additional records 40 are generated as the unit of the food commodity travels through the supply chain path 102. Here, the same tracked item ID “000123” corresponding to the producer unit-specific identifier 32 is used for the producer and transporter, as the same unit of the food commodity (wheat) travels through the supply chain path. Next, the different tracked item ID “000246” corresponding to the processor unit-specific identifier 34 is created for the first intermediate processor and the tracked item ID “000123” for wheat is recorded as the previous tracked item ID, as the unit of the food commodity (wheat) has transformed to the unit of another food commodity (flour). Next, the different tracked item ID “000369” corresponding to the product unit-specific identifier 30 is further created for the second intermediate processor and the tracked item ID “000246” for bread is recorded as the previous tracked item ID, as the unit of the food commodity (flour) has transformed to the unit of the food product (bread). Finally, the same tracked item ID “000369” corresponding to the product unit-specific identifier 30 is utilized for the second intermediate processor and merchant, as the same unit of the food product (bread) travels through the supply chain path. As a result, the supply chain path 102 may include a branched supply chain path with one node at the unit of the food product and leaf nodes at one or more producers or intermediate processors of units of food commodities that are included within the unit of the food product 22.

Finally, the camera-equipped computing device 20 of the user receives the supply chain derived information 28 on the unit of the food product 22 generated via the supply chain derived information output module 54 of the server computing device 12. The supply chain derived information 28 can be utilized by the user to check sustainability, quality, and nutrition of the unit of the food product 22. This may provide insights on sustainability, quality and/or nutrition over time since harvest, and tracking information for use in recalls or other safety procedures, as some examples. The supply chain derived information 28 can be raw information (such as sensor readings or path location points) or a processed result that has been computed or derived based on gathered raw information. For example, the supply chain derived information 28 on the unit of the food product 22 may include a metric 68 that can be computed based on the records of data obtained through the supply chain path 102. The metric 68 may include a traceability metric that indicates a series of static locations and transit segments in the supply chain and the duration of time spent at each location and transit segment by the unit of the food product 22 and/or constituent units of food commodities in the food product 22. The metric 68 may further include a shelf-life metric, nutrition metric, and/or sustainability metric. The metric 68 may be computed based on time at temperature at each stage in the supply chain path 102. The metric 68 may be computed by utilizing a machine learning model. For instance, the amount of protein in a given unit of food product such as bread may be estimated, via the machine learning model, based on the information traced from the supply chain entities.

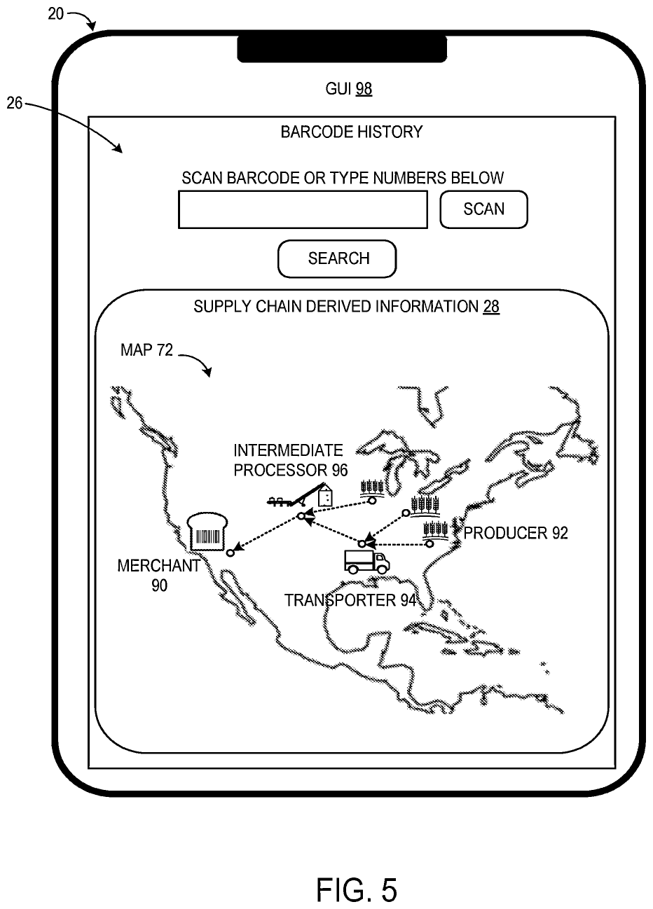

The supply chain derived information 28 on the unit of the food product 22 may further includes a ledger 70 in the database including the records of data obtained through the supply chain path, and a map 72 including the locations of the supply chain entities. Turning briefly to FIGS. 4 and 5, FIG. 4 illustrates an example ledger 70 in the database including the records of data to be output by the server computing device 12 and displayed on a camera-equipped computing device 20. As shown at FIG. 4, the ledger 70 may include a table showing a supply chain entity ID, tracked item ID, previous tracked item ID, scanned time, location information (e.g., latitude and longitude), and meta data for each record ID. The tracked item ID and previous tracked item ID correspond to the unit-specific identifiers 30, 32, 34 of FIG. 1. Furthermore, FIG. 5 illustrates an example map 72 including the locations of the supply chain entities to be output by the server computing device 12 and displayed on a camera-equipped computing device 20. As shown at FIG. 5, the map 72 provides an intuitive traceability of the unit of the food product, indicating a branched supply chain path with one node at the unit of the food product and leaf nodes at one or more producers of units of food commodities.

It will be appreciated that the supply chain derived information 28 may be accessed through a web dashboard or a mobile application. The web dashboard may be designed to provide more insights on the actual information gathered at each supply chain stage. For example, temperature alerts can be displayed within the mobile application, and a regulatory agent (human actor) can open the web dashboard to track the actual temperature changes over time and debug issues based on these records. Similarly for nutrition, a summary notification of one or more points of incorrect handling temperatures can be noted in the mobile application, while detailed information regarding these points of incorrect handling temperatures can be made available on the web dashboard. Furthermore, the level of detail of the supply chain derived information 28 to be presented may be adjusted depending on the type of the user. For instance, a consumer may receive a simple metric, while a regulatory agent pursuing safety recalls may receive more details.

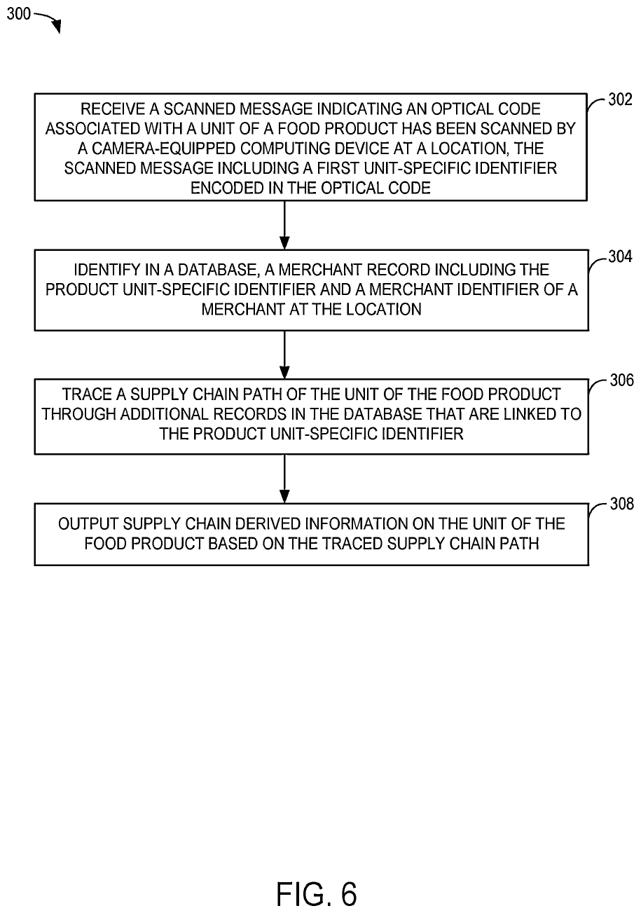

FIG. 6 is a flowchart of a method 300 for achieving traceability in a food commodity supply chain according to one example configuration of the present disclosure. At step 302, the method 300 may include receiving a message indicating an optical code associated with a unit of a food product has been scanned by a camera-equipped computing device at a location, the message including a product unit-specific identifier encoded in the optical code. The optical code associated with the unit of the food product may include a barcode, a Quick Response (QR) code, and/or an alphanumeric code.

Continuing from step 302 to step 304, the method 300 may include identifying in a database, a merchant record including the product unit-specific identifier and a merchant identifier of a merchant at the location.

Advancing from step 304 to step 306, the method 300 may include tracing a supply chain path of the unit of the food product through additional records in the database that are linked to the product unit-specific identifier. The additional records may include records of data obtained from supply chain entities including a producer, transporter, distributor, intermediate processor, and/or merchant. The additional records may further include a producer record including a producer unit-specific identifier that is linked to the product unit-specific identifier and including a producer identifier of a producer and a location of the producer. The additional records may further include a transporter record including a processor unit-specific identifier that is linked to the product unit-specific identifier and the producer unit-specific identifier and including a transporter identifier of a transporter and a location of the transporter.

Proceeding from step 306 to step 308, the method 300 may include outputting supply chain derived information on the unit of the food product based on the traced supply chain path. The supply chain derived information on the unit of the food product may include a traceability metric that indicates a series of static locations and transit segments in the supply chain and the duration of time spent at each location and transit segment by the unit of the food product and/or constituent units of food commodities in the food product. The supply chain derived information on the unit of the food product may further include a map including the locations of the supply chain entities.

The quality, grade, and use of agricultural products are determined by the areas of origin, growing processes, harvesting based on agricultural management zones, and transportation and storage of the harvested crop. For example, crops that are sprayed with herbicides and/or grown in the presence of chemical fertilizers may be distributed and priced differently than crops that are not sprayed with herbicides, grown without specific fertilizers, and/or grown on non-till soil for carbon benefits. Such information is useful to the farmers and agricultural organizations, as well the buyers down the supply chain, especially for grains that are aggregated in large silos after being harvested in large volumes across different management zones. The computing system 100 and method 300 described herein provide mechanisms for achieving traceability in a food commodity supply chain with use of an optical code. This system enables retention of traceability information for harvested crops throughout the supply chain, which enables consumers and other purchasers of the products to verify the source of the food commodities with greater confidence. The system of the present disclosure utilizes the optical code (e.g., barcode and QR code) that is low cost, scalable, and provides supply chain information with sufficient accuracy to meet the needs of supply chain traceability.

In some embodiments, the methods and processes described herein may be tied to a computing system of one or more computing devices. In particular, such methods and processes may be implemented as a computer-application program or service, an application-programming interface (API), a library, and/or other computer-program product.

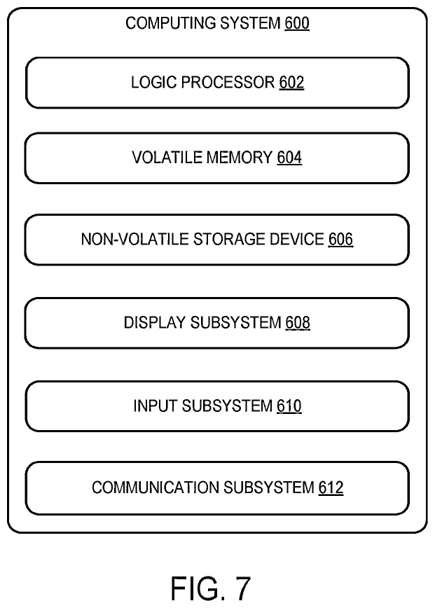

FIG. 7 schematically shows a non-limiting embodiment of a computing system 600 that can enact one or more of the methods and processes described above. Computing system 600 is shown in simplified form. Computing system 600 may embody the server computing device 12 described above and illustrated in FIG. 1. Computing system 600 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 7.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” may be used to describe an aspect of computing system 600 typically implemented in software by a processor to perform a particular function using portions of volatile memory, which function involves transformative processing that specially configures the processor to perform the function. Thus, a module or program may be instantiated via logic processor 602 executing instructions held by non-volatile storage device 606, using portions of volatile memory 604. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs provide additional support for the claims of the subject application. One aspect provides a computing system for achieving traceability in a food commodity supply chain. The computing system may include a server computing device having one or more processors configured to execute instructions using portions of associated memory to receive a message indicating an optical code associated with a unit of a food product has been scanned by a camera-equipped computing device at a location, the message including a product unit-specific identifier encoded in the optical code. The processors may be further configured to identify in a database, a merchant record including the product unit-specific identifier and a merchant identifier of a merchant at the location. The processors may be further configured to trace a supply chain path of the unit of the food product through additional records in the database that are linked to the product unit-specific identifier. The processors may be further configured to output supply chain derived information on the unit of the food product based on the traced supply chain path.

According to this aspect, the supply chain path may include a branched supply chain path with one node at the unit of the food product and leaf nodes at one or more producers of units of food commodities that are included within the unit of the food product.

According to this aspect, the additional records may include records of data obtained from supply chain entities including a producer, transporter, distributor, intermediate processor, and/or merchant.

According to this aspect, the additional records may include a producer record including a producer unit-specific identifier that is linked to the product unit-specific identifier and including a producer identifier of a producer and a location of the producer.

According to this aspect, the additional records may include a post-production record including a processor unit-specific identifier that is linked to the producer unit-specific identifier and including an intermediate processor identifier of an intermediate processor and a location of the intermediate processor.

According to this aspect, the additional records may include a post-production record including the processor unit-specific identifier that is linked to the producer unit-specific identifier and the product unit-specific identifier and including an intermediate processor identifier of an intermediate processor and a location of the intermediate processor.

According to this aspect, the optical code associated with the unit of the food product may include a barcode, a Quick Response (QR) code, and/or an alphanumeric code.

According to this aspect, the supply chain derived information on the unit of the food product may include a traceability metric that indicates a series of static locations and transit segments in the supply chain and the duration of time spent at each location and transit segment by the unit of the food product and/or constituent units of food commodities in the food product.

According to this aspect, the supply chain derived information on the unit of the food product may include a shelf-life metric, nutrition metric, and/or sustainability metric.

According to this aspect, the supply chain derived information on the unit of the food product may include a ledger in a database including the records of data.

According to this aspect, the supply chain derived information on the unit of the food product may include a map including the locations of the supply chain entities.

According to another aspect of the present disclosure, a computerized method for achieving traceability in a food commodity supply chain is provided. According to this aspect, the computerized method may include receiving a message indicating an optical code associated with a unit of a food product has been scanned by a camera-equipped computing device at a location, the message including a product unit-specific identifier encoded in the optical code. The computerized method may further include identifying in a database, a merchant record including the product unit-specific identifier and a merchant identifier of a merchant at the location. The computerized method may further include tracing a supply chain path of the unit of the food product through additional records in the database that are linked to the product unit-specific identifier. The computerized method may further include outputting supply chain derived information on the unit of the food product based on the traced supply chain path.

According to this aspect, the supply chain path may include a branched supply chain path with one node at the unit of the food product and leaf nodes at one or more producers of units of food commodities that are included within the unit of the food product

According to this aspect, the additional records may include records of data obtained from supply chain entities including a producer, transporter, distributor, intermediate processor, and/or merchant.

According to this aspect, the additional records may include a producer record including a producer unit-specific identifier that is linked to the product unit-specific identifier and including a producer identifier of a producer and a location of the producer.

According to this aspect, the additional records may include a post-production record including a processor unit-specific identifier that is linked to the product unit-specific identifier and the producer unit-specific identifier and including an intermediate processor identifier of an intermediate processor and a location of the intermediate processor.

According to this aspect, the optical code associated with the unit of the food product may include a barcode, a Quick Response (QR) code, and/or an alphanumeric code.

According to this aspect, the supply chain derived information on the unit of the food product may include a traceability metric that indicates a series of static locations and transit segments in the supply chain and the duration of time spent at each location and transit segment by the unit of the food product and/or constituent units of food commodities in the food product.

According to this aspect, the supply chain derived information on the unit of the food product may include a map including the locations of the supply chain entities.

According to another aspect of the present disclosure, a computer system for achieving traceability in a food commodity supply chain is provided. The computing system may include a server computing device having one or more processors configured to execute instructions using portions of associated memory to receive a producer data entry from a producer, the producer data entry including production information for a unit of a food commodity. The processors may be further configured to generate a producer label configured to be placed on the unit of the food commodity or packaging thereof, the producer label including an optical code encoding a producer unit-specific identifier. The processors may be further configured to write the producer data entry to a database receive a message indicating a scan of the producer label by the camera-equipped computing device of a supply chain entity. The processors may be further configured to receive a post-production data entry from the supply chain entity, the post-production data entry including post-production supply chain information and a product unit-specific identifier that is linked to the producer unit-specific identifier. The processors may be further configured to generate a post-production label configured to be placed on the unit of the food commodity or packaging thereof, the post-production label including the optical code encoding the product unit-specific identifier. The processors may be further configured to write the post-production data entry to the database. The processors may be further configured to receive a message indicating a scan of the post-production label by a camera-equipped computing device of a merchant. The processors may be further configured to output a ledger including the product information and/or the post-production supply chain information to the camera-equipped computing device of the merchant.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for achieving traceability in a food commodity supply chain, the computing system comprising:
a server computing device having one or more processors configured to execute instructions using portions of associated memory to:
receive a message indicating an optical code associated with a unit of a food product has been scanned by a camera-equipped computing device at a location, the message including a product unit-specific identifier encoded in the optical code;
identify in a database, a merchant record including the product unit-specific identifier and a merchant identifier of a merchant at the location;
trace a supply chain path of the unit of the food product through additional records in the database that are linked to the product unit-specific identifier; and
output supply chain derived information on the unit of the food product based on the traced supply chain path.

2. The computing system of claim 1, wherein
the supply chain path includes a branched supply chain path with one node at the unit of the food product and leaf nodes at one or more producers of units of food commodities that are included within the unit of the food product.

3. The computing system of claim 1, wherein
the additional records include records of data obtained from supply chain entities including a producer, transporter, distributor, intermediate processor, and/or merchant.

4. The computing system of claim 1, wherein
the additional records include a producer record including a producer unit-specific identifier that is linked to the product unit-specific identifier and including a producer identifier of a producer and a location of the producer.

5. The computing system of claim 4, wherein
the additional records include a post-production record including a processor unit-specific identifier that is linked to the producer unit-specific identifier and including an intermediate processor identifier of an intermediate processor and a location of the intermediate processor.

6. The computing system of claim 4, wherein
the additional records include a post-production record including the processor unit-specific identifier that is linked to the producer unit-specific identifier and the product unit-specific identifier and including an intermediate processor identifier of an intermediate processor and a location of the intermediate processor.

7. The computing system of claim 1, wherein
the optical code associated with the unit of the food product includes a barcode, a Quick Response (QR) code, and/or an alphanumeric code.

8. The computing system of claim 1, wherein
the supply chain derived information on the unit of the food product includes a traceability metric that indicates a series of static locations and transit segments in the supply chain and the duration of time spent at each location and transit segment by the unit of the food product and/or constituent units of food commodities in the food product.

9. The computing system of claim 8, wherein
the supply chain derived information on the unit of the food product includes a shelf-life metric, nutrition metric, and/or sustainability metric.

10. The computing system of claim 3, wherein
the supply chain derived information on the unit of the food product includes a ledger in a database including the records of data.

11. The computing system of claim 3, wherein
the supply chain derived information on the unit of the food product includes a map including the locations of the supply chain entities.

12. A computerized method for achieving traceability in a food commodity supply chain, comprising:
receiving a message indicating an optical code associated with a unit of a food product has been scanned by a camera-equipped computing device at a location, the message including a product unit-specific identifier encoded in the optical code;
identifying in a database, a merchant record including the product unit-specific identifier and a merchant identifier of a merchant at the location;
tracing a supply chain path of the unit of the food product through additional records in the database that are linked to the product unit-specific identifier; and
outputting supply chain derived information on the unit of the food product based on the traced supply chain path.

13. The computerized method of claim 12, wherein
the supply chain path includes a branched supply chain path with one node at the unit of the food product and leaf nodes at one or more producers of units of food commodities that are included within the unit of the food product.

14. The computerized method of claim 12, wherein
the additional records include records of data obtained from supply chain entities including a producer, transporter, distributor, intermediate processor, and/or merchant.

15. The computerized method of claim 12, wherein
the additional records include a producer record including a producer unit-specific identifier that is linked to the product unit-specific identifier and including a producer identifier of a producer and a location of the producer.

16. The computerized method of claim 15, wherein
the additional records include a post-production record including a processor unit-specific identifier that is linked to the product unit-specific identifier and the producer unit-specific identifier and including an intermediate processor identifier of an intermediate processor and a location of the intermediate processor.

17. The computerized method of claim 12, wherein
the optical code associated with the unit of the food product includes a barcode, a Quick Response (QR) code, and/or an alphanumeric code.

18. The computerized method of claim 14, wherein
the supply chain derived information on the unit of the food product includes a traceability metric that indicates a series of static locations and transit segments in the supply chain and the duration of time spent at each location and transit segment by the unit of the food product and/or constituent units of food commodities in the food product.

19. The computerized method of claim 14, wherein
the supply chain derived information on the unit of the food product includes a map including the locations of the supply chain entities.

20. A computing system for achieving traceability in a food commodity supply chain, the computing system comprising:
a server computing device having one or more processors configured to execute instructions using portions of associated memory to:
receive a producer data entry from a producer, the producer data entry including production information for a unit of a food commodity;
generate a producer label configured to be placed on the unit of the food commodity or packaging thereof, the producer label including an optical code encoding a producer unit-specific identifier;
write the producer data entry to a database;
receive a message indicating a scan of the producer label by the camera-equipped computing device of a supply chain entity;
receive a post-production data entry from the supply chain entity, the post-production data entry including post-production supply chain information and a product unit-specific identifier that is linked to the producer unit-specific identifier;
generate a post-production label configured to be placed on the unit of the food commodity or packaging thereof, the post-production label including the optical code encoding the product unit-specific identifier;
write the post-production data entry to the database;
receive a message indicating a scan of the post-production label by a camera-equipped computing device of a merchant; and
output a ledger including the product information and/or the post-production supply chain information to the camera-equipped computing device of the merchant.
